(19) United States
(12) Patent Application Publication
(10) Pub. No.: US 2020/0316761 A1
(43) Pub. Date: Oct. 8, 2020

(54) MOWER BLADE REMOVAL TOOL

(71) Applicant: Randal L. Hoyt, Vandalia, MO (US)

(72) Inventor: Randal L. Hoyt, Vandalia, MO (US)

(21) Appl. No.: 16/802,074

(22) Filed: Feb. 26, 2020

Related U.S. Application Data
(60) Provisional application No. 62/828,739, filed on Apr. 3, 2019.

(51) Int. Cl. B25B 33/00; A01D 34/00

(52) U.S. Cl. CPC B25B 33/00; A01D 2101/00; A01D 34/001

(57) ABSTRACT

A tool is provided for assisting in the removal and installation of blades on a rotary mower. The tool is configured to limit rotation of a blade during blade fastener tightening and loosening. Blade rotation is limited even after a fastener is loosened, allowing loosening or tightening of a second fastener.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 62/828,739, entitled “MOWER BLADE REMOVAL TOOL”, filed Apr. 3, 2019. The contents of the above referenced application are incorporated herein by reference in its entirety.

### FIELD OF THE INVENTION

The present invention relates to a tool configured to assist in removing and installing blades carried by a lawnmower deck.

### BACKGROUND OF THE INVENTION

Lawnmowers (hereinafter referred to as mower or mowers) of the rotary type are well known in the art. There are other types of mowers; for example, a reel mower, such as those used on golf courses. The present invention relates to a tool for assisting in the removal of the blades on a rotary type mower.

Rotary mowers come in two basic types, a walk behind using a single blade and a riding type that has multiple blades. The multiple blade mowers will typically have two or three blades mounted to a deck that provides protection for the blades, as well as blade and associated spindle support. The blades on rotary mowers rotate in a plane generally parallel to the underlying support surface, such as a yard or garage floor. In three blade mowers, the center blade is typically leading or following the two outer blades so that their paths overlap to prevent leaving a swath of uncut grass. In two blade mowers, the blade ends are spaced from one another when the blades are in line and opposed to prevent interference since their rotations are not fixedly timed to one another.

From time to time, one or more of the blades will need to be maintained by sharpening or replacement. On rotary mowers, this is problematic. Mowers are not provided with means to resist rotation of the blade when its mounting fastener, such as a nut or bolt retaining the blade to the mower deck spindle, is being loosened to allow removal of the blade or tightened to install a blade. Also, some of the fasteners utilize left-handed threading, while others utilize right-handed threading. Another problem is that the mower deck is positioned close to the underlying support surface, such as a garage floor or yard, making access to the blade fasteners difficult. Some mowers are provided with a built-in stand or jack mechanism to elevate the front end of the mower and a portion of the mower deck to allow more room to access the fasteners. Some mowers are designed to have the blades maintained by removal of the mower deck, which is at least inconvenient, if not difficult. Some mowers, however, have easily removable and installable decks, such as John Deere with their drive over decks. Mower decks on many mowers, particularly heavy duty mowers, are heavy and difficult to manipulate for removal and installation when working alone. Regardless of how access to a blade is accomplished, the blades are free to rotate during fastener loosening and tightening.

One method of loosening the blade fasteners with the deck attached is to use an impact wrench; but because of the limited space under the deck, the mower is elevated at least at the front wheels to provide room for the impact wrench. Many mower users do not have this latitude with many of the currently manufactured mowers. And, few people have an impact wrench. However, one brand of mower has a power lift on the mower deck which turns the deck generally perpendicular to the support surface, providing easy access to the blades. However, the blades can still turn instead of the fastener being loosened or tightened. There is thus a need for a tool which will assist in preventing blade rotation during blade fastener loosening and tightening. While the above description discusses loosening, the same problem occurs in reverse when attempting to tighten the blade fastener after the blade has been either sharpened or replaced.

### DESCRIPTION OF THE PRIOR ART

There are several tools disclosed in the prior art or in use that are designed to assist in limiting movement of the blade during blade removal and installation. An example of such a device is called the Arnold blade removal tool. It is commercially available. It utilizes a bracket that attaches to the mower deck using a threaded T-handle. Tightening of the handle secures the bracket against movement relative to the mower deck. The bracket is provided with a pair of spaced apart stops that receive one end of the blade therebetween, limiting movement of the blade in both counterclockwise and clockwise movement. With the blade positioned between the stops, a wrench can be applied to the blade fastener to either effect loosening or tightening. Such a device is particularly effective for use on a single blade walk behind mower. However, such a device is not well adapted for use with a three blade mower deck because of the difficulty in attaching it to the deck to limit rotation of the middle blade. Also, on many of the multi-blade decks, it would be difficult to find a deck portion that is convenient to mount the tool to, while allowing it to limit rotation of a blade because of the shape of the mower deck and the location of grass clippings flow directing baffles.

A second type of tool is a handle device that fits onto a blade and, in a sense, acts as a second wrench, whereby the person removing or installing the blade holds that tool while operating the fastener wrench. Such a tool would be difficult, if not impossible, to use on a three blade deck. Such a tool is disclosed in U.S. Pat. Nos. 4,956,905 and 6,272,724. They appear to be particularly well adapted for a single blade mower, but require the person removing the blade to independently operate this removal tool and simultaneously provide loosening/tightening torque and rotation resisting torque.

A third type of blade removal tool is disclosed in U.S. Pat. No. 6,796,111. This tool does not require holding by the person doing the blade removal as do the second type tools described above. This tool is a stop that is removably mounted on the mower deck. It is installed when the blade is to be removed; and after blade maintenance, it is removed from the mower deck. It requires drilling a hole in the mower deck.

A fourth type of blade removal tool is disclosed in U.S. Pat. No. 6,276,039. It is a simple block that temporarily clamps to the mower deck and is positioned on the inside of the deck to engage the blade and resist rotation in only one direction without reversing the position of the blade about one half turn to resist opposite blade rotation direction.

Another means of resisting blade rotation during fastener loosening and tightening is a wedge, typically of wood, that is jammed between the outer end of the mower blade and the inside surface of the mower deck. This, however, is not a positive stop to movement of the blade during removal or re-installment. It is a homemade device. A block, typically wood, can also be clamped to the inside of the mower deck and is also homemade.

So called brush hogs, that have a hinged blade arrangement, utilize a hole through the mower deck that aligns with the fastener, holding the outer portion of the blade to the inner portion of the blade mounting hub. A wrench is inserted through the hole with the edge of the hole, limiting rotation of the blade and hub, and movement of the fastener, allowing the fastener to be loosened or tightened.

### SUMMARY OF THE INVENTION

The present invention provides an improved tool for assisting in removing and installing mower blades of the rotary type.

Accordingly, it is a primary objective of the present invention to provide a tool that can be used for both installing and removing mower blades on a single or multi-blade rotary mower deck.

It is a further objective of the present invention to provide a tool that can be used on multiple sizes of blades.

It is yet another objective of the present invention to provide a tool that can be used on any mower deck with one or more blades.

It is a still further objective of the invention to provide a tool that does not require mower elevation or deck removal to use.

Other objects and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a perspective view of the tool showing the blade couplers at opposite ends of the connecting beam;

FIG. 2 is a perspective view of the tool showing one of the blade couplers moved to a more central position along the beam, with blade positions being shown schematically;

FIG. 3 is a perspective view of the underside of a mower deck, with the tool installed on two adjacent blades mounted to blade spindles;

FIG. 4 is a perspective view of a riding lawnmower of the zero-turn type;

FIG. 5 is a perspective view of the tool with a blade shown within one of the couplers;

FIG. 6 is an end view of a first modified form of coupler;

FIG. 7 is an end view of a second modified form of coupler with a space filler clip; and

FIG. 8 is an isometric view of a third modified form of tool.

### DETAILED DESCRIPTION OF THE INVENTION

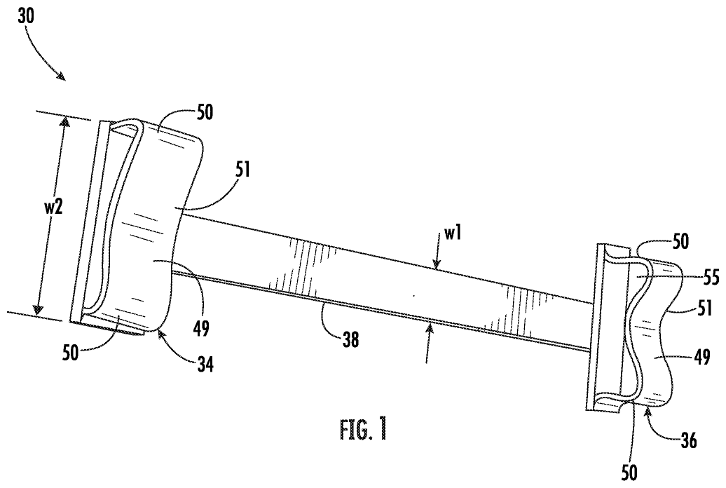

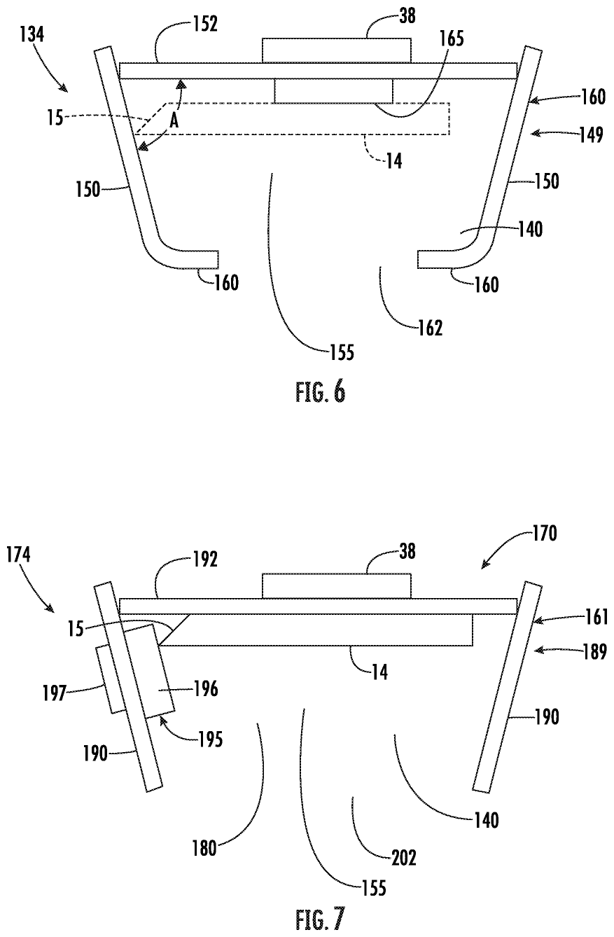

FIGS. 1-5 show a preferred embodiment of the present invention. The tool 30 is configured to bind two adjacent lawnmower (hereinafter mower) blades 14 against rotational movement to simultaneously limit their movement to loosen their respective fastener to effect blade maintenance. As described below, the tool 30 can also be used to bind a single blade 14 on a single blade mower using the blade and a portion of the mower deck 12 to fix the blade against rotation. FIGS. 6, 7, 8 illustrate modified forms of couplers as described to achieve the same functionality.

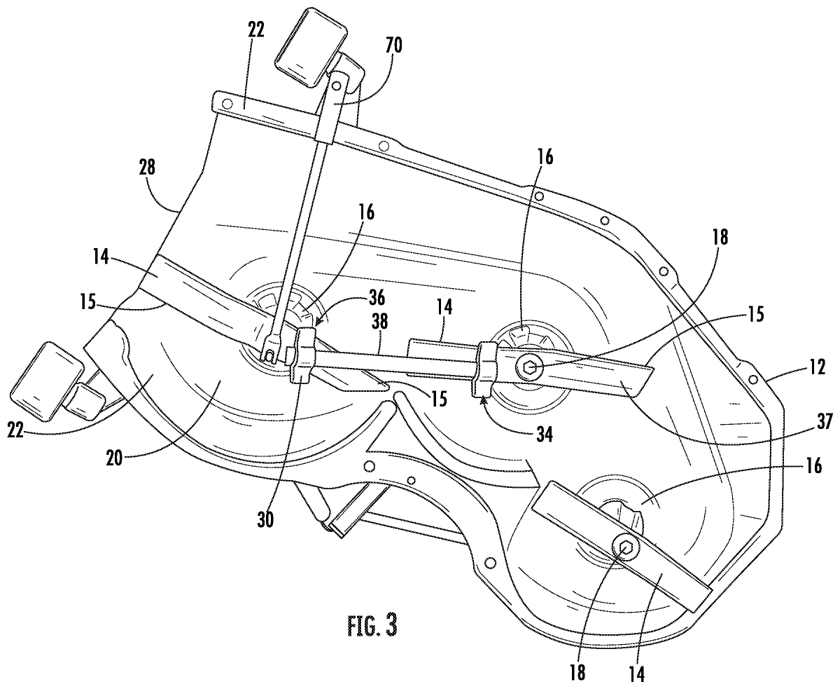

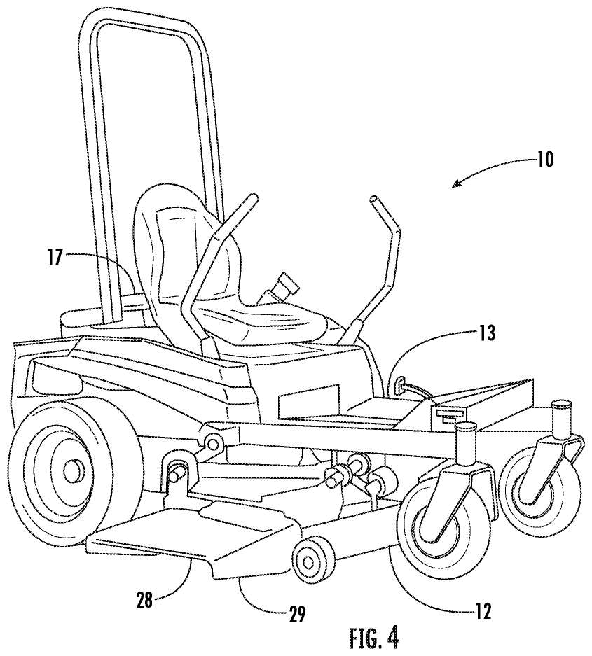

Referring to FIG. 4, the reference numeral 10 designates generally a mower having a so-called belly mower deck 12 mounted to the chassis 13 of the mower 10. The illustrated mower 10 is a multi-blade riding mower that can be of the zero-turn type or standard turning type as are known in the art. While the described mower is a multi-blade mower, it is to be understood that the below described tool 30 can also be used on a single blade mower in a manner described below. Typically, the mower 10 is provided with means to raise and lower the deck 12, and retain it at a desired cutting height relative to the underlying support surface, such as a lawn or garage floor. Many brands of such mowers are available on the market and have varying features, qualities and types of blades, such as standard blades that are substantially flat and so called high lift blades that have an upwardly bent fin portion trailing the cutting edge that increases airflow. The mower deck 12 is provided with a plurality of blades 14 (FIG. 3), each mounted on a respective blade spindle 16 with a fastener 18 that can be either a threaded nut or bolt, usually with a hex or spline portion for wrench engagement. The blades 14 are on the underside of the deck 12, and the spindles 16 typically have a portion above the deck for coupling to blade drive components and a portion below the deck for blade mounting and spacing from deck components. On the upper side of the deck 12, drive coupling means such as pulleys, not shown, are provided for ultimate connection to the motor 17 of the mower 10 for effecting rotation of the blades 14 to effect mowing and/or mulching, or even lawn vacuuming. A mulching attachment, not shown, can be provided, as is known in the art, if desired. Orientation and operational terms, as used herein, are used in the sense of when the mower is in its normal mowing orientation and/or operation. In the case of a walk behind single blade mower, the blade is mounted to the mower motor shaft, not a spindle. A blade 14 is a generally rectangular metal plate having a length exceeding its width, usually with a pair of sharpened edge portions 15 along portions of opposite edges of the blade, and is mounted at its center point which has a through bore for receipt of the fastener 18.

The deck 12 has an upper generally planar top portion 20 on which the spindles 16 are mounted. Typically, the deck 12 will be provided with a depending skirt 22 that shields the blades 14 from contact with some objects and a user's foot or other appendage. The skirt 22 and top portion 20 define a discharge opening 28. Suitable safety devices can be provided, as are known in the art, such as a grass clipping discharge deflector 29.

A tool 30, as best seen in FIGS. 1, 2 and 3, is provided for assisting in the removal and installation of a mechanical fastener 18 that mounts each of the blades 14 to a respective spindle 16. The tool 30 is adapted for use by mounting on the bottom side of adjacent blades 14 or alternately, on top of the blades 14. It is also adapted for use to fix the blade 14 on a single blade mower against rotation. In use on a multi-blade mower 10, the tool 30 is removably mounted to a pair of adjacent blades 14. The fastener 18 can be a threaded nut attached to a threaded shank, or a threaded bolt received in a threaded bore. The fastener 18 can be either left-handed or right-handed, depending on the make and model of the particular mower 10 and its normal blade rotation direction. The tool 30 has a plurality of couplers and, as shown, a pair of blade couplers 34, 36 connected to each other by a beam 38, forming a yoke to couple two blades together to resist rotation of the coupled blades during loosening or tightening of a fastener 18. The tool 30, through the configuration of couplers 34, 36 (and other embodiments thereof described below), in use is operable to limit blade rotation and to releasably retain the tool 30 mounted on one or more blades 14. In the illustrated structure, the beam 38 is an elongate structural member that can have a generally rectangular cross-section, both transversely and longitudinally, for ease of manufacturing and use. The beam 38 has a length of between about 6 inches and about 18 inches. Preferably, its width W1 is between about ½ inch and about 1.5 inches, and has a thickness between about 0.1 inch and about ¼ inch. It is to be noted, however, that the shape of the beam can be any suitable shape. In a preferred embodiment, the beam 38 is generally planar on its opposite main surfaces and straight, and its area moment of inertia (I) is sufficient to resist permanent deformation under anticipated loading during use.

As shown, the couplers 34, 36 have openings 40, 42, respectively, that preferably are of generally the same size and shape, and are adapted to receive therein, and preferably therethrough, a free end portion of a respective blade 14 of a pair of adjacent blades 14. When the tool 30 is mounted to adjacent blades 14, contact between the blades and the surfaces defining the openings 40, 42 of their respective coupler 34, 36 will resist rotation of the coupled blades during loosening and tightening of a fastener 18. Sameness of shape and size allows the tool to be used in an orientation that has no handedness, i.e., either end will work on either blade 14, and which edge is sharp is not relevant. The tool 30 will also work for left and right handed fasteners 18. The width W2 of the inside of the couplers 34, 36 is at least about 1.5 inches and preferably at least about 3 inches. This allows for a variety of widths of blades 14, which are typically in the range of about 1.5″ and about 3″ wide for home mowers.

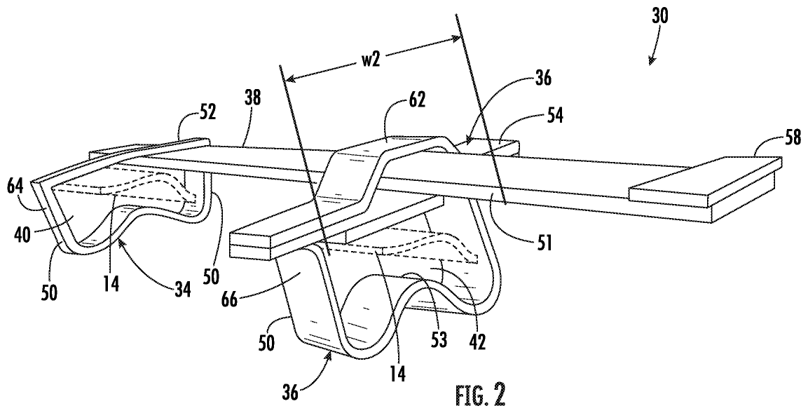

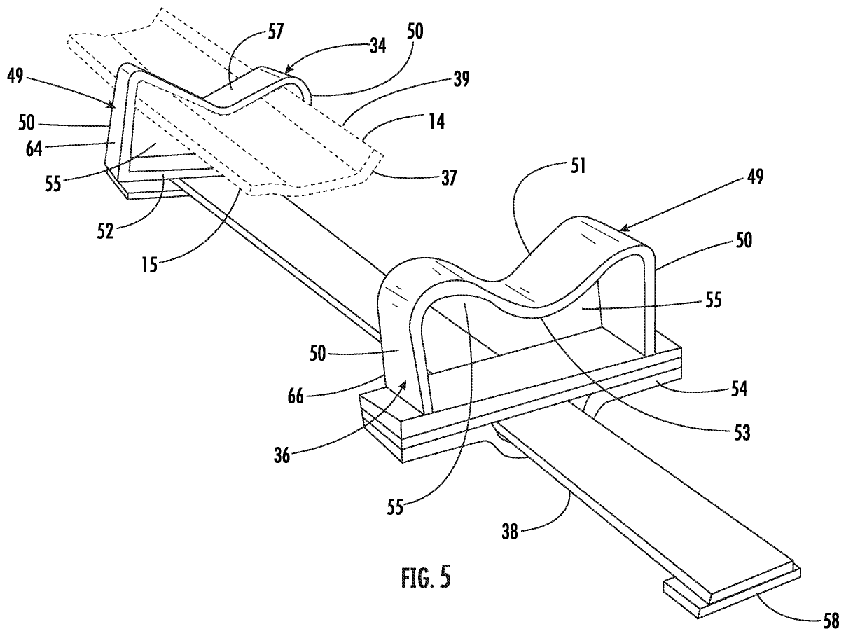

A basic type mower blade 14 is generally planar. It functions to both cut the grass and discharge it through the mower deck 12 discharge 28. There are two other types of blades, a mulching blade and a lift blade, that can provide various degrees of lift or suction. Mulching blades have a longer cutting edge with an upwardly curved section. The difference between the two blades is the contour of the free end portion of the blade 14. A high lift blade would have a wing section 37 with a fin 39, FIG. 5, projecting a large distance above the main planar portion of the blade, while a basic blade may have a small fin or no fin at all. The length of the beam is preferably long enough to allow the couplers 34, 36 to be positioned beyond opposite ends of the blade curved sections. The preferred tool 30 is able to accommodate many or all typical types of blades in a single tool, i.e., a tool for generally universal use. As best seen in FIGS. 1 and 2, the cross-sectional shape of the openings 40, 42 is configured to accommodate different types of blades, and left and right-handed blades simultaneously. The openings 40, 42 are defined by portions of the couplers 34, 36 respectively. Preferably, the opening 40, 42 are similarly shaped and sized. While the illustrated shape of openings 40, 42 is preferred, openings with generally rectangular transverse cross sections could be used, as well as any other suitable shape. As seen, the openings 40, 42 are somewhat M-shaped (simultaneously W-shaped but inverted) in transverse cross section and defined partially by legs 50, bight 51 of the couplers 34, 36 and respective cross members 52, 54. The bight 51 forms a retainer 49 configured to releasably retain the tool 30 on a blade during use. The couplers 34, 36 each have generally upstanding spaced apart legs 50 forming blade stops to limit blade rotation. The retainer 49, in the embodiment shown in FIG. 1, includes a curved section such as the U or V-shaped bight portion 51 of the M-shape extending therebetween, defining a passage 55, each providing access to by a respective opening 40, 42. The passages 55 are also partially defined by cross members 52, 54 connecting the legs 50 together and retaining the legs in spaced relationship. The legs 50 may be secured to or integral with a respective cross member 52, 54. Preferably, the passages 55 of the couplers 34, 36 are in substantial axial alignment to facilitate non-handedness of the tool 30. The bight portion 51 has the apex 53 spaced from the respective cross member 52, 54 a distance to accommodate a mower blade portion, while the enlarged portions of the passages 55 will accept the wing section 37 and fin 39 of the blade therein (FIG. 5). The cross members 52, 54 may be integral with respective legs 50, or suitably secured thereto as by welding.

As best seen in FIG. 2, the couplers 34, 36 are preferably able to move relative to one another, i.e., toward and away from one another along the beam 38. Because the illustrated beam 38 is substantially straight, the relative movement is substantially linear. Relative movement facilitates installation and removal of the tool 30 on adjacent blades 14 on a multi-blade mower 10. As shown, the coupler 36 is movable along a substantial portion of the length of the beam 38. In the illustrated embodiment, the coupler 36 is movable relative to the beam 38, while the coupler 34 is fixed to the beam 38 to prevent relative movement therebetween. A stop 58 is secured to the beam to limit movement of the coupler 36, and prevents separation of the coupler 36 from the beam 38. The coupler 36 has the cross member 54 positioned and extending between its legs 50, and includes a guide channel 62 secured to or integral with the cross member 54, movably mounting the coupler 36 to the beam 38 for longitudinal movement therealong.

The coupler 34 is similar in construction to the coupler 36, and has its cross member 52 extending between its legs 50, but is preferably permanently secured to the beam 38, fixing its position relative to the beam 38. The cross member 52 can be secured to or integral with the legs 50. In a preferred embodiment, the couplers 34, 36 and the beam 38 are made from a mild steel, or other suitable metal, with the assemblies being preferably effected by welding or the like. Each of the couplers 34, 36 forms a blade receiving channel 64, 66 respectively. The blade receiving channels 64, 66 are sized and shaped to receive a lawnmower blade therein during use of the tool 30. In use of the illustrated couplers 34, 36, a pair of adjacent blades 14 are captured for limited rotational movement inside the channels 64, 66. In the illustrated structure, the channels 64, 66 are formed by the legs 50 and respective cross members 52, 54. The legs 50 in each coupler 34, 36 function as stops, engaging opposite side edges of a respective blade 14 with one blade limiting the movement of the other blade by binding against the legs 50.

Use of the tool 30 on a multi-blade mower 10 is illustrated in FIG. 3. Preferably, if the deck 12 is not to be removed, the deck is moved to its uppermost position to provide more room under the deck. The front end of the mower 10 could also be elevated to provide more working room. The movable coupler 36 is moved toward the coupler 34 an appropriate distance. The coupler 34 is then placed on a blade 14 with the beam 38 being on the underside of the blade. The ends of two adjacent blades 14 are then positioned rotationally relative to one another about their axes of rotation on a respective spindle 16, such that the coupler 36 can be moved onto its respective blade 14 and extended to the coupler stop 58. Preferably, the center of the beam 38 is positioned at the gap between the ends of the blades 14 to center the tool 30 on the adjacent blades 14. After some initial rotation of the blade 14 that is to have its fastener 18 loosened or tightened, some additional rotation of this blade 14 relative to the other blade 14 is effected by a wrench 70 coupled to the respective fastener 18. Blade rotation can also be effected by hand. After the initial blade rotation, the blades 14 then bind within their respective coupler 34, 36 and channel 64, 66 by engaging with at least two respective legs 50, preventing further rotation and allowing the user of the wrench 70 to either loosen the fastener 18 or tighten the fastener 18 as desired. The wider the blade 14 for a given coupler separation distance, the less relative blade rotation is needed to achieve rotational binding. After completion of blade maintenance and reinstallation, if the blade is removed, the tool 30 is removed by again moving the coupler 36 toward the coupler 34 and then removing the tool from its respective blade 14. Use of the tool 30 is basically the same if the couplers 34, 36 are not relatively movable for use.

In the case of a single blade mower, one or both couplers 34, 36 is/are positioned on the blade 14, preferably with the couplers 34, 36 being spaced apart an adequate distance. A portion of the beam 38 is positioned to engage a deck portion, such as an edge defining the discharge opening 28. The fastener 18 can then be loosened or tightened with the tool 30, preventing blade rotation.

FIG. 6 illustrates a second embodiment 130 of the present invention. It utilizes a coupler 134 similar to the couplers 34 and 36, but without the bight 51. The coupler 134 includes a retainer, designated generally 149, and a pair of spaced apart legs 150 mounted to a cross member 152, at least partially forming a channel 161. At least one of the legs 150 has an arm 160 projecting inwardly therefrom toward an opposite leg 150, partially forming an open throat 162 between the legs. As shown, each leg 150 includes an arm 160. The arm or arms 160 form the retainer 149. The legs 150, arms 160, and cross member 152 at least partially define a blade receiving opening 140 and passage 155. The legs 150, arms 160 and cross member 152 can be an integral structure or a welded assembly as desired. The legs 150 converge toward one another, going away from the cross member 152 to also function as a blade retainer. The angle A between the cross member 152 and legs 150 is less than 90° to induce movement of a blade 14 to engage the cross member 152 during use of the tool 130. Preferably, the angle A is between about 45° and about 80°. This same angular arrangement can be used with the first embodiment described above for the legs 50. In use, the tool 130 would be mounted on the top sides of the blades 14, letting gravity hold it in place initially and the legs 150 function as a blade retainer when a blade is bound between the legs 150 to function as stops.

As shown in FIG. 6, an alternate or additional retainer can be provided to removably mount the tool 30 or 130 in position on the underside of the blades 14. Such a retainer could be a magnet 165, straps including hook and loop fasteners, or other suitable means. Such a retainer can be in addition to or in lieu of the retainers 49 and 149.

FIG. 7 illustrates a third embodiment 170 of the present invention. It utilizes a coupler 174 similar to the couplers 34, 36, but without the bight 51 or arms 160. The coupler 174 includes a retainer, designated generally 189, that includes a pair of spaced apart legs 190 mounted to a cross member 192. The legs 190 in this embodiment serve two functions, as a blade stop and as a blade retainer. In this embodiment, the arms 160 shown in FIG. 6 are not used. The legs 190 form an open throat 202. The legs 190 and cross member 192 at least partially define a blade receiving opening 140 and associated passage 155, and form a channel 161. The legs 190 and cross member 192 can be an integral structure or a welded assembly as desired and as described above. Preferably, the above described angle A is the same for the positional relationship between the legs 190 and cross member 192. In use, the tool 170 could be mounted on the top sides of the blades 14, letting gravity hold it in place initially. On the FIG. 7 embodiment shown, means can be provided with the above described retainer, such as a magnet 165 (described above) to removably mount the tool 170 in position on the underside of the blades 14. The coupler 174 can also include a removably mounted spacer clip 195 that includes a spacer 196 positioned to fill space between a blade 14 edge and an inside surface of a leg 190 to reduce play and to reduce blade rotation to effect blade binding. A clip 197, such as a spring clip, effects mounting of the spacer clip 195 to a leg 190. The spacer clip 195 can be likewise mounted to a leg 50 or a leg 150.

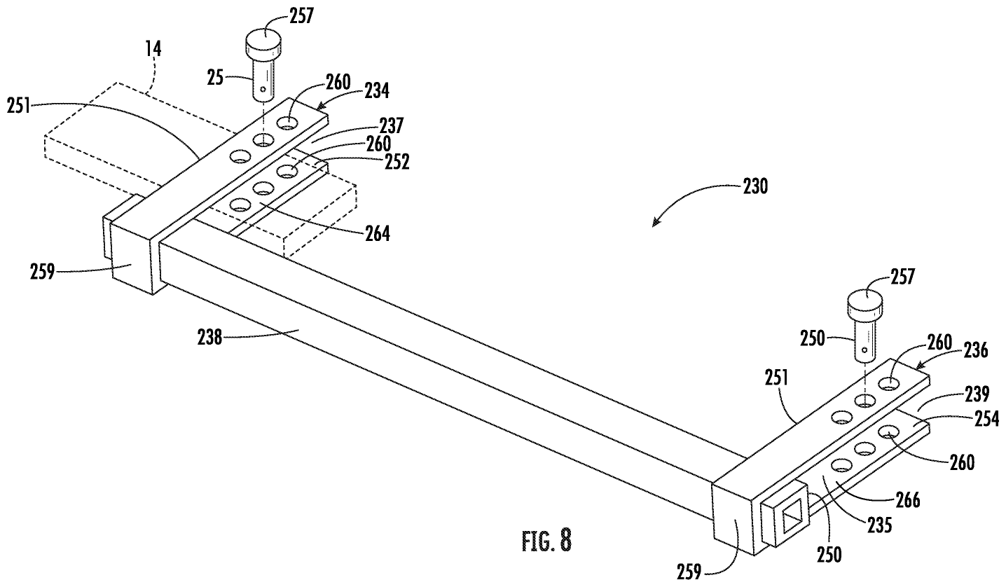

FIG. 8 shows another embodiment of the invention, as tool 230, which is particularly adapted for mounting on blades 14 with lateral movement onto one or more blades 14 instead of transverse movement, as in the couplers 34, 36 of tool 30 shown in FIG. 1 and the other above described coupler embodiments. The couplers 234, 236 are of the same general construction, each having a side opening 235 into a respective passage 237, 239 for receipt of a blade 14 in a passage. A beam 238 has the couplers 234, 236 mounted therein, in either a fixed position relationship or in a relatively movable relationship as with the couplers 34, 36 and their beam 38. The couplers 234, 236 each have a bight member 251 and a cross member 252, 254 (similar in function to the bight member 52, 54 described above). Since the illustrated tool 230 is symmetrical top and bottom, the bight and cross member functions are reversible, one going above a blade 14 and one going below a blade with the bight being on top. The coupler 234, 236 can be formed of a U-shaped member and secured to the beam 238 by having the beam positioned between the bight 251 and cross member 252, 254 which are connected by a bridge member 259. The bight 251 and associated cross member 252, 254 can be separate parts secured to the beam 238. Either the beam 238 or bridge member 259 can function as a leg 250 and stop, as described above for a leg 50. A second leg 250 is provided and, as shown, is part of the pin 257 removably mounted to a bight 251 and associated cross member 252, 254 and serves as a second leg, like a leg 50 described above. The pin 257 and first leg 250 and cross member 252, 254 form a channel 264, 266 respectively, as described above for channels 64, 66. Each of the bights 251 and cross members 252, 254 have at least one through opening 260 that is aligned in a coupler 234, 236 to provide for removable mounting of a pin 257. The pin 257 can be in the form of a detent pin, latch pin or a threaded fastener, such as a bolt and associated nut. Preferably, each bight 251 and cross member 252, 254 has a plurality of aligned pairs of openings 260 to accommodate blades 14 of different widths by adjusting the width of the coupler 234, 236.

The embodiments of FIGS. 6, 7 and 8 operate the same as the couplers 34, 36 to bind one mower blade 14 or an adjacent pair of blades 14 between two pairs of legs 50, 150, 160 or 250 to enable fastener 18 tightening or loosening. The couplers 134, 174 can be used instead of one or both couplers 34, 36. In preferred embodiments, the couplers 34, 36, 134, 174 are symmetrical about a center point between their respective legs 50, 150 and 190.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A tool for facilitating removal and installation of lawnmower blades, the tool compromising:
a beam; and
a plurality of couplers mounted on the beam, each said coupler having a lawnmower blade receiving channel sized and shaped to receive a lawnmower blade therein, said channels each having a pair of spaced apart stop members connected by a cross member, each said stop member of a coupler being positioned for engagement with a respective edge of a lawnmower blade when positioned in a said coupler.

2. The tool as set forth in claim 1 wherein said couplers each define a through passage.

3. The tool as set forth in claim 2 wherein said through passages are substantially in alignment.

4. The tool as set forth in claim 2 wherein at least one said coupler is movably mounted on said beam and is selectively movable relative to another said coupler.

5. The tool as set forth in claim 2 wherein at least one said coupler having a pair of spaced apart legs projecting from a cross member mounted to said beam, said legs forming at least a portion of a respective said stop member and partially defining a respective said passage.

6. The tool as set forth in claim 5 wherein at least a pair of said couplers each having a pair of spaced apart legs projecting from a respective said cross member mounted to said beam, said legs of each said coupler forming at least a portion of respective said stop members and partially defining a respective said passage.

7. The tool as set forth in claim 6 including a retainer associated with said legs of a respective said coupler and operable to retain a lawnmower blade in said passages during use of the tool.

8. The tool as set forth in claim 7 wherein the retainer including a bight extending between and connected to at least one said leg of a respective pair of said legs of a said coupler.

9. The tool as set forth in claim 8 wherein said bight being generally U-shaped and connected to both said legs of a respective pair of said legs, said bight having an apex of the U-shape extending toward a respective said cross member.

10. The tool as set forth in claim 9 wherein said legs on at least one said coupler converge toward one another from its respective cross member toward said bight.

11. The tool as set forth in claim 7 wherein there being a pair of said couplers with one being fixed to said beam and the other being selectively movable on said beam and including a stop member secured to said beam operable to limit movement of said movable coupler along said beam.
